(19) United States
(12) Patent Application Publication
(10) Pub. No.: US 2008/0077471 A1
(43) Pub. Date: Mar. 27, 2008

(54) Controllable automated generator of optimized allied product content

(75) Inventors: Tim Musgrove, Morgan Hill, CA (US); Steve Krause, San Francisco, CA (US); Howard Burrows, Oakland, CA (US); Robin Hiroko Walsh, San Francisco, CA (US)

Correspondence Address: NIXON PEABODY, LLP, 401 9TH STREET, NW, SUITE 900, WASHINGTON, DC, 20004-2128, US

(73) Assignee: CNET Networks, Inc., San Francisco, CA (US)

(21) Appl. No.: 11/702,662

(22) Filed: Feb. 6, 2007

Related U.S. Application Data
(60) Provisional application No. 60/765,173, filed on Feb. 6, 2006.

(51) Int. Cl. G06Q 30/00; G06F 17/40; G06F 19/00

(52) U.S. Cl. 705/10

(57) ABSTRACT

An automated and highly scalable system and method optimizes the selection of allied products in association with a main product. Initially, a plurality of allied products is identified. Each allied product is categorized to determine attributes by which the allied products are evaluated. Each allied product is rated to create a ranked list of allied products. Content, such as textual information, corresponding to each of the allied products is automatically generated using assertion models. Highly customized optimization rules are then applied to refine the ranked list and select optimal allied products. In one application, the optimization rules may be based on business requirements and the selected allied products are cross-sold with the main product on an online retail web site.

This application claims priority to U.S. Provisional Application No. 60/765,173, filed Feb. 6, 2006, the contents of which are entirely incorporated herein by reference.

### BACKGROUND OF THE INVENTION

1. Field of the Invention

The present invention is generally directed to the processing of product-related data, and more particularly, to automated selection of, and generation of data for, products that are associated with a main product.

2. Description of Related Art

Cross-sell merchandising is a major part of commerce generally, and e-commerce in particular. Cross-selling involves encouraging customers to buy additional, complementary, or related accessories or products during or just after their purchase of a primary, or “main,” product. Cross-sell merchandising may have more importance for online retailers, as opposed to brick-and-mortar retailers, because the online shopping environment gives consumers the ability to compare prices quickly with search engines or “pricebots.” This, in turn, creates market pressures which drive prices down to near-zero profit margins for the main product of interest to the consumer, such as a TV, computer, or MP3 player. As a result, the online retailer must then attempt to make profit, if any, on the cross-sell items that are added to the online shopping cart just prior to the final purchase step. These cross-sell items typically have a higher mark-up.

On the other hand, brick-and-mortar merchants generally have customers who are physically present and who cannot easily check prices of other merchants at other locations. Therefore, brick-and-mortar merchants experience less pressure to lower their prices on the primary purchase items, and hence have less need to engage in cross-sell promotions. Nonetheless, brick-and-mortar retailers are not likely to neglect any opportunity for profit, and so they too pursue cross-sell merchandizing, though perhaps to a lesser degree than their online counterparts. Thus, the optimization of cross-sell promotion is of very high interest to traditional retailers as well as online merchants.

Consumers also have an interest in merchants' efforts to cross-sell. For instance, consumers purchase many products that require the purchase of, among other things, additional batteries to operate the product, connectors to attach the product with other devices, or a protective case to prevent damage to the product. Cross-selling makes the purchase of such accessories more convenient. In general, if the cross-sell items are relevant to the main product, are of good quality, and are reasonably priced, cross-selling may be beneficial to the consumer.

Cross-selling, however, is difficult to perform efficiently on a large scale, because:
A good deal of labor and knowledge may be required to select items for cross-selling, particularly when a large catalog is involved.
Cross-sell items, such as accessories, connectors, or supplies, change very frequently in the marketplace, so that the selection process may need to be repeated frequently.
Certain types of accessories are more compatible with certain types of products, depending on very specific features of both the accessory and the main product. Thus, the consumer needs to have information on the relationship between the accessory and the main product, in order to assess the relevance of the accessory.

In both online and offline retail sales, cross-sell items are often almost randomly selected after the application of only a limited number of very crude selection rules. For example, an external mouse may be suggested for any and every laptop computer that is sold, without regard to whether the laptop is a very high-end laptop and or whether the mouse is a very cheap one. Any refinement in matching accessories to the main product, e.g. placing a neon-colored mouse with a bright neon-colored computer, is usually accomplished manually, one product at a time.

This repetitious manual effort may be very expensive and time-consuming for the retailer, and therefore, is only feasible when used for a very small fraction of all products. Another disadvantage is that knowledge and information are required to make refined selections and to explain to the consumer why the selection is being recommended. Employing a more knowledgeable staff usually costs the retailer more money than a less knowledgeable staff.

Preferably, the specifications of every product are examined closely to ensure compatibility and, perhaps more importantly, sensibility. For example, preferably, one not only verifies that an external plug-in hard drive is of a compatible type, but also that the external plug-in hard drive is large enough to backup the flll capacity of the internal hard drive. Clearly, this type of analysis is more time consuming, and demands even more knowledge, which is acquired and applied only at great cost to the retailer. Moreover, even if a retailer decides to bear the cost and conduct this in-depth analysis, the carefully selected and matched products may be cycled out of the marketplace within a few months and may be replaced with other products that need to be examined anew.

A further complication is that selection of cross-sell items may be subject to a variety of business-related rules and requirements. For example, a reseller may require a license to distribute certain brands, and may not have such a license for one or more brands that are popular. In addition, a retailer carrying a plurality of brands may have an agreement regarding one of the brands, which requires the retailer to show accessories under the specific brand, wherever and whenever it displays any accessories at all. Moreover, a retailer may have excess inventory of a particular accessory and may wish to deplete that inventory by promoting those items above others. Also, a retailer may wish to promote more often items that have the largest mark-up or that are seldom subject to customer returns which are very costly to the retailer. When such factors are taken into account, the selection of cross-sell items for the retailer becomes exponentially more complicated, and thus, much harder to maintain or to scale up.

Consumers have also determined that retailers are often trying to push accessory sales that are more beneficial to the retailer than the consumer. For this reason, consumers often consult with an unbiased 3rd party, such as an editorially-driven magazine or website that does not sell the products it reviews. Although such organizations do not sell or cross-sell products, they face the same challenges that retailers face. In other words, they too must constantly select which accessories to recommend and explain the rationale for their selection, a process that must be repeated as products in the marketplace change. Because the cross-selling recommendations for accessories, connectors, parts, and supplies come from impartial editors as well as merchants, the term “allied products” is used to encompass all accessories, connectors, parts, and supplies, regardless of whether they are being editorially recommended or being cross-sold by merchants.

Because the editorial organizations do not sell allied products, their selection of allied products is generally not subject to business rules as described above. In fact, making recommendations based on profit might damage their reputations. Nonetheless, editorial organizations do apply some selection rules that influence their final recommendations. In particular, editorial organizations also face a scalability problem and they simply cannot manually examine every accessory in the marketplace. For instance, editorial organizations may find that a certain brand of accessories consistently has higher quality than another brand. As a result, they are entitled editorially to prioritize their review of products according to the relative quality of the brands. In addition, brands may be emphasized or presented differently by the editors according to a quality ranking. Alternatively, editors may feel that a particular feature or format of a type of allied product is simply not useful to users generally, regardless of which brand or manufacturer it comes from, and they may wish to avoid recommending allied products which bear that feature.

Generally, editorial organizations require the ability to make good selections among many thousands of allied products annually, with readily available explanation, and without the exorbitant costs of analyzing and writing about each one manually.

Furthermore, retailers and reviewers are interested in the behavior of users and of industry influencers. If a particular allied product is very popular among users or is drawing a lot of attention in the industry, then despite the business- or editorial-related selection rules in place, the retailers and reviewers may wish to promote or emphasize the particular product in some way merely because of its popularity. In addition, regardless of the initial opinions and recommendations by retailers and editors, the opinions of consumers can be measured from the number of times a product is returned or from “user opinion” tallies on editorial websites. Often consumer experience and opinion runs counter to the recommendations from retailers or editors. Therefore, it may be preferable to receive input from the sales channel and even the direct opinions of generally users (or more authoritative or “certified” users) when selecting and recommending allied products.

### SUMMARY OF THE INVENTION

In view of the foregoing, an advantage of embodiments of the present invention is in providing an automated and highly scalable system and method for optimizing the selection of allied products.

An additional advantage of embodiments of the present invention is in providing an automated and highly scalable system and method for categorizing each allied product to enable optimized selection of allied products.

Another advantage of embodiments of the present invention is in providing an automated and highly scalable system and method for rating each allied product to create an initial pool of candidate allied products from which optimal allied products are selected.

Still another advantage of embodiments of the present invention is in providing an automated and highly scalable system and method of applying optimization rules for selecting allied products from an initial pool of candidate allied products.

A further advantage of embodiments of the present invention is in providing an automated and highly scalable system and method for applying the knowledge and experience of product experts to the optimized selection of allied products.

Yet another advantage of embodiments of the present invention is in providing an automated and highly scalable system and method of generating, with assertion models, content, i.e. variant texts, corresponding to a selection of allied products.

Also, an advantage of embodiments of the present invention is in providing an automated and highly scalable system for selecting allied products according to business rules in order to cross-sell the allied products with a main product in a manner required by a specific merchant.

Another advantage of embodiments of the present invention is in providing an automated and highly scalable system for selecting allied products for cross-selling with a main product on an online retail website.

A further advantage of embodiments of the present invention is in providing an automated and highly scalable system for presenting content for cross-selling allied products on an online retail website according to specified business rules.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 illustrates an example of a relationship of hypothetical allied products to a hypothetical main product.

FIG. 2 illustrates a flow chart for an exemplary embodiment of the present invention.

FIG. 3 illustrates a flow chart for rating an allied product in an exemplary embodiment of the present invention.

FIG. 4 illustrates another flow chart for rating an allied product in an exemplary embodiment of the present invention.

FIG. 5 illustrates a chart of exemplary inputs for the development of optimization rules in an exemplary embodiment of the present invention.

### DETAILED DESCRIPTION

Allied products are goods and services that are associated with another good or service, also referred to as a main product. Allied products may include accessories, connectors, parts, and supplies that merchants are cross-selling with a main product. As used herein, merchants refer to any seller of goods and services, including, but not limited to, manufacturers, distributors, and retailers. Alternatively, allied products may include accessories, connectors, parts, and supplies that third party editorials, such as online product reviews, recommend for use with a main product. It is understood, however, that the association between allied products and a main product may be based on any criteria and employed for any application. Also, it is also understood that main products may themselves be allied products for other main products in a nested arrangement. For example, an MP3 player may be considered to be an allied product for a main product, such as a laptop, while at the same time, an appropriate pack of batteries may be considered an allied product where the MP3 player is the main product.

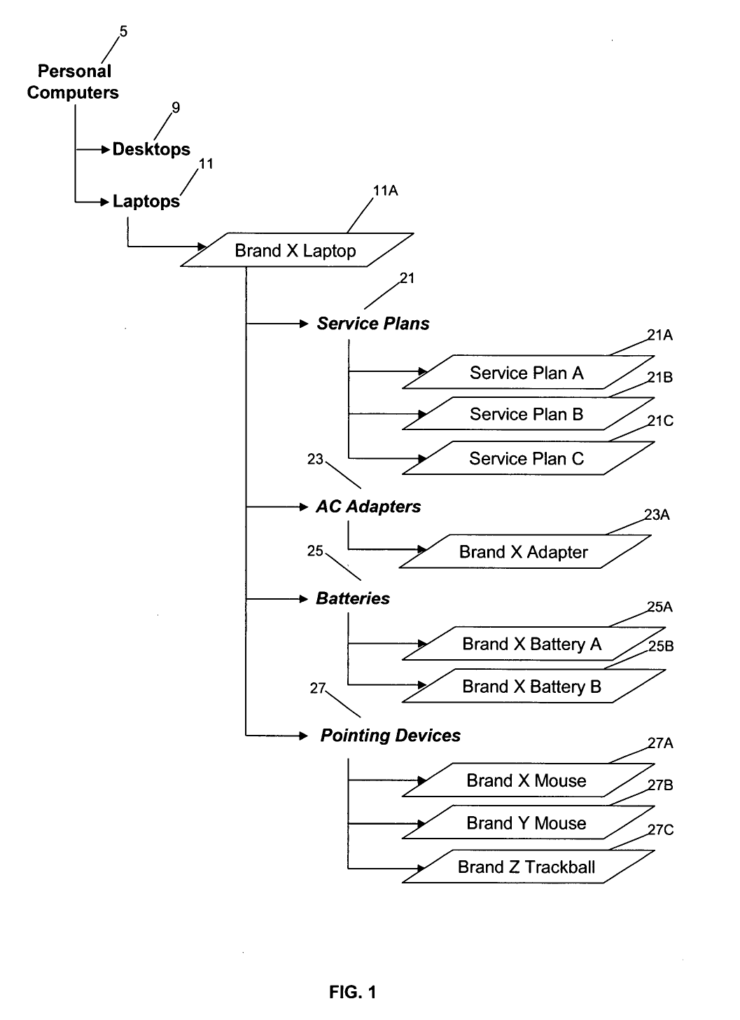

FIG. 1 illustrates hypothetical allied products that are associated with a hypothetical main product, Brand X Laptop 11A, which is a laptop computer sold under the brand X. Service Plan A 21A, Service Plan B 21B, and Service Plan C 21C provide buyers with repair service for Brand X Laptop 11A. Brand X Adapter 23A is used as a power adapter with Brand X Laptop 11A. Additionally, Brand X Battery A 25A and Brand X Battery B 25B are two different battery types A and B that can be used by Brand X Laptop 11A. Meanwhile, Brand X Mouse 27A, Brand Y Mouse 27B, and Brand Z Trackball 27C are used as peripheral accessories for Brand X Laptop 11A. Although the products 21A, 21B, 21C, 23A, 25A, 25B, 27A, 27B, and 27C relate to varying categories, types, and brands of products, the products can be associated in some way with the main product Brand X Laptop 11A. As such, these products may be considered allied products for Brand X Laptop 11A.

Embodiments of the present invention automate selection of allied products in association with a main product. In particular, these embodiments automatically create an optimal list of allied products based on optimization rules. The optimal list may include automatically generated content, such as textual information, that corresponds to each allied product. Due to the automated aspects of the present invention, embodiments may be implemented on a computer system or other programmable processing system capable of making repeated calculations or evaluations.

In an exemplary application, the optimal list of allied products represents products that can be cross-sold by a merchant on an online website. For example, with reference to FIG. 1, an embodiment may apply a certain set of business-based optimization rules to automatically select, out of an entire universe of products, the allied products 21A, 21B, 21C, 23A, 25A, 25B, 27A, 27B, and 27C. In accordance with the merchant's business requirements, the embodiment then automatically generates content for each of these allied products, which is then presented on a web page. In particular, the content includes text that informs consumers about the association between each allied product and Brand X Laptop 11A. In this way, the merchant is able to recommend and cross-sell these selected allied products with Brand X Laptop 11A in an automated and efficient manner. Advantageously, the system is highly scalable and a large mass of allied product data may be processed to produce the optimized cross-sell list.

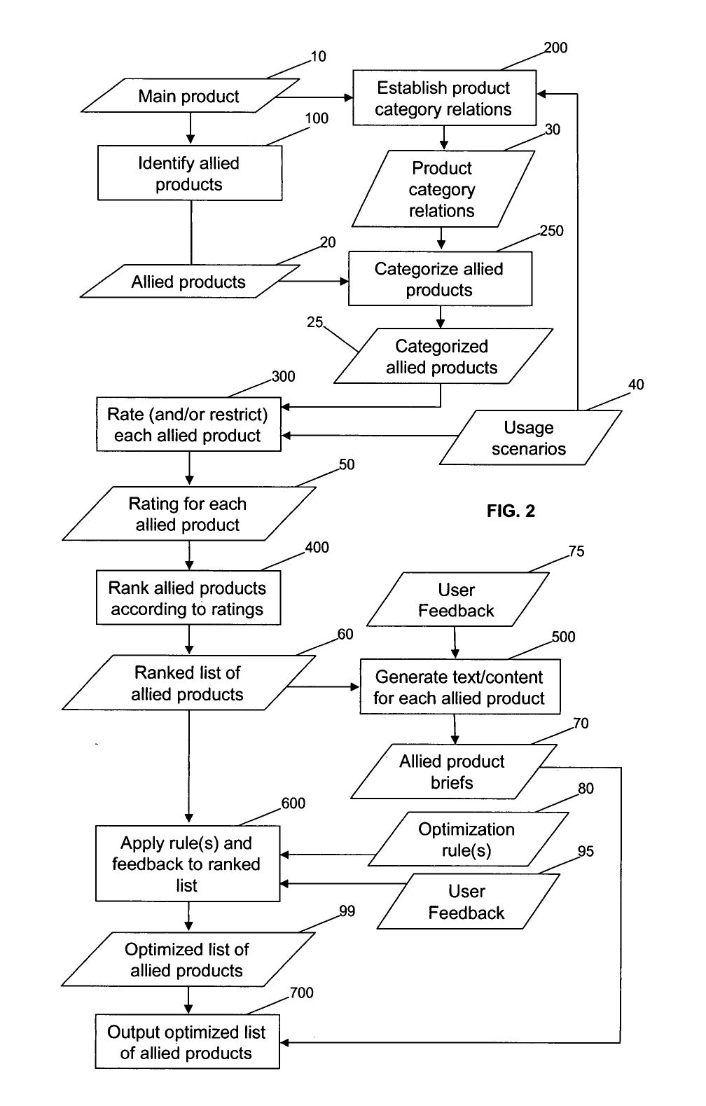

FIG. 2 illustrates an exemplary embodiment of the present invention. As further shown in FIG. 2, data regarding main product 10 is an input for step 100. In general, the data described in FIG. 2 may be stored on any type of storage device that enables access to information, particularly by a computer system. Moreover, the data may be stored on more than one unit or one type of storage. For instance, multiple sources may provide information for the main product. As such, the information on the main product 10 may be stored on different types of storage devices located in varying systems and locations.

In general, step 100 processes the data on the main product 10 to identify an initial pool of candidate allied products 20. As described in detail below, allied products are selected from this initial candidate pool 20 in an automated manner in order to form an optimized list of allied products 99. In general, no initial restrictions are imposed by step 100 when identifying the allied products 20. The allied products 20 may be any number of products of varying categories, types, and brands. Indeed, a large number of initial allied products 20 provides more choices for the selection of allied products for the optimized list 99.

Step 200 also receives information on the main product 10. From this input, product category relations 30 are identified. Product category relations 30 describe the relationship that exists between product categories and the main product 10. The relationship between a product category and the main product 10 corresponds with a set of relevant attributes that are common to all the allied products in that product category. By identifying the relevant attributes associated with product categories, product category relations 30 enable allied products to be evaluated according to these attributes.

Referring to FIG. 1, the products 21A, 21B, 21C, 23A, 25A, 25B, 27A, 27B, and 27C fall under the following product categories: Service Plans 21, AC Adapters 23, Batteries 25, and Pointing Devices 27. Each product category indicates each allied product's relationship with the main product, Brand X Laptop 11A. For instance, Brand X Mouse 27A, Brand Y Mouse 27B, and Brand Z Trackball 27C are characterized by attributes common to pointing devices used with Brand X Laptop 11A.

Since broad product category relations 30 may be few in number and may remain fairly static, step 200 may be executed manually. For example, human editors may employ their understanding of the main product 10 to identify categories for allied products. This information may be manually recorded in a simple knowledge representation scheme in an initial set-up. The products within a certain category all have a particular relationship with the main product 10. The human editors use their expertise to identify the relevant attributes of a product category in relation to the main product 10. For instance, referring again to FIG. 1, an editor may determine that certain allied products, such as mice and trackballs, bear an important relation as pointing devices for laptop computers. Thus, a product category relation corresponding to such pointing devices, i.e. product category 27, is established in step 200.

Optionally, product relationships between a main product and allied products may be hierarchically arranged so that a product category relation may be inherited by other main products. For example, in FIG. 1, Personal Computers 5, Laptops 9, and Desktops 11 may be characterized as types of main products. However, Desktops 9 and Laptops 11 actually fall hierarchically under Personal Computers 5. In this example, a relationship between Personal Computers 5 and Pointing Devices may be inherited by Desktops 9 and Laptops 11. Thus, Laptops 11 also has a product category 27 for Pointing Devices.

Step 200 may employ usage scenarios 40 to identify more relevant product category relations 30. A type of usage scenario is described in U.S. application Ser. No. 10/839,700, filed May 6, 2004, entitled SYSTEM AND METHOD FOR GENERATING AN ALTERNATIVE PRODUCT RECOMMENDATION, the contents of which are incorporated herein by reference. In general, a usage scenario indicates the purpose or intended use for a product. In step 200, usage scenarios 40 are employed to define further, or restrict, the product category relations 30 that are initially identified. For instance, step 200 may identify joysticks as an allied products category. However, this particular category may be associated more specifically with personal computers that are used for gaming, i.e. a “gamer-oriented” usage scenario, and not all personal computers. As demonstrated by this example, the usage scenario better defines the relationship of allied products, i.e. joysticks, to a main product, i.e. personal computers used for gaming.

Once the product category relations 30 are identified in step 200, each allied product is then appropriately categorized in step 250. The categorized allied products 25 can then be used by step 300 to determine the relevant attributes that are used to rate each allied product. As indicated previously, product category relations 30 identify the attributes by which allied products may be evaluated to determine a rating 50. The rating 50 of each allied product is then employed to select optimal allied products as described further below.

To rate the allied products in step 300, a total scalar value may be assigned to each allied product according to relevant attributes of the allied product based on its product category. In general, each attribute is accorded a point value, and the sum of point values for all attributes provides the total scalar value. In some instances, points may be deducted, as a penalty, from the total scalar value if an attribute of an allied product fails to meet certain criteria, thus making it more likely that the allied product will have a lower rating.

For some embodiments, step 300 may remove some allied products completely from further consideration. When an attribute of an allied product makes the allied product unlikely to be selected in subsequent processing and selection, step 300 may eliminate the particular product completely, rather than decreasing a point value from the total scalar value for the allied product. In other words, the pool of candidate allied products 20 that are available for selection is restricted, or reduced, by the application of particular rules during step 300.

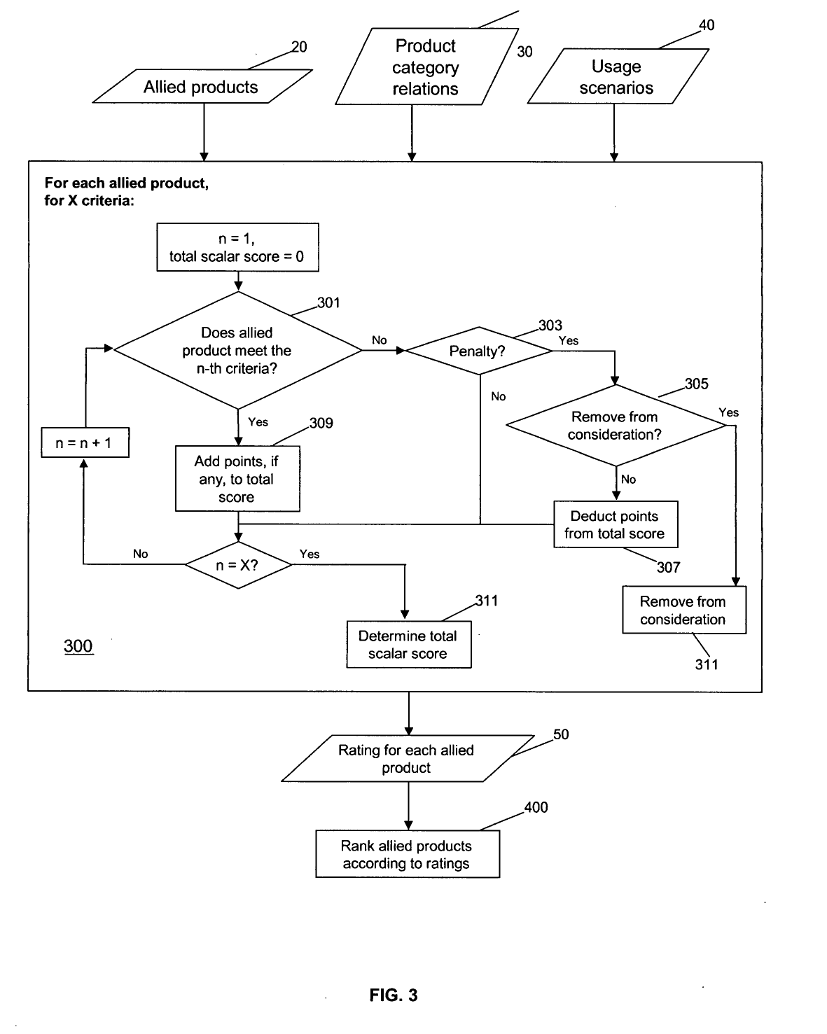

FIG. 3 illustrates an exemplary approach for rating and/or restricting the allied products in step 300. As shown in FIG. 3, sub-step 301 evaluates an allied product by determining whether the allied product and its attributes meet particular criteria. If the allied product fails to meet the criteria, the process proceeds to sub-step 303, which determines whether there should be a penalty. If there is no penalty for failing to meet the criteria, the process proceeds to evaluation of any additional criteria. However, if a penalty is required, the process proceeds to sub-step 305 which determines what penalty to apply. If the allied product should be eliminated as a candidate allied product, the process proceeds to sub-step 311 where the allied product is made unavailable for subsequent selection. If elimination of the allied product is not required, the processing advances to the sub-step 307 where points are deducted from the total scalar score of the allied product. On the other hand, if at sub-step 301, the allied product and its attributes meet the particular criteria, points are added in step 309 to the total scalar score of the allied product, if necessary. As shown in FIG. 3, there may be any number of criteria X by which the allied product is rated. As discussed previously, the criteria depend on the product category. If the allied product must be tested against criteria n=1 . . . X, the process loops back to sub-step 301 where the next criteria n=n+1 is applied, assuming that allied product has not been eliminated in sub-step 311.

In one embodiment, sub-step 301 shown in FIG. 3 may evaluate an allied product by determining whether it has a certain attribute in connection with a specific usage scenario. As described previously, a usage scenario indicates the purpose or intended use for a product. In this case, the usage scenario can be used to restrict an allied product or to provide a scalar rating for an allied product. For example, if a usage scenario involves “business use” of a personal computer, an allied software product that contains “Home Edition” in its description might be eliminated from further consideration. A dictionary of equivalent phrases for “Home Edition” may be employed as a reference when this particular usage scenario analysis is applied. If in sub-step 301, the allied product is determined not to have the appropriate attribute regarding the given usage scenario, the process proceeds to sub-step 303. In the previous example, for personal computers designated for “business use,” software such as Microsoft Office Home Edition may be eliminated in sub-step 311 in favor of Microsoft Office Professional or Microsoft Office Small Business Edition. Alternatively, the “Home Edition” allied product is not eliminated, but points are deducted from its total scalar value in sub-step 307, making it more likely that the “Home Edition” allied product ends up with a lower rating. On the other hand, if the allied product is more compatible with business use, the process proceeds to sub-step 309 where points, if required, may be added to the total scalar value, making it more likely that the particular allied product ends up with a higher rating.

In another embodiment, sub-step 301 may evaluate an allied product by comparing an attribute of the allied product with an attribute of the main product. For example, where the allied product is an auxiliary hard-drive and the main product is a laptop, the capacity of the auxiliary hard-drive may need to be at least equal to or greater than the capacity of the laptop's main drive. Thus, in sub-step 301, the capacity of the auxiliary hard-drive is evaluated against the capacity of the laptop's main drive. If the attribute of the allied product is not compatible with the attribute of the main product, the process proceeds to sub-step 303 as described previously. However, if the allied product is compatible with the attribute of the main product, the process moves to sub-step 309 as also described previously.

In yet another embodiment, sub-step 301 may evaluate an allied product according to an absolute or relative price point. For instance, sub-step 301 may apply a rule that attempts to pair laptops costing more than $2,000 with mice costing more than $50. On the other hand, another rule may attempt to pair laptops priced in the top 25% of the market with mice that are at least in the top 40% of the market, with respect to price. Such rules reflect a consumer behavioral pattern, in which consumers buying higher end main products, such as laptops, tend to purchase higher end accessories. Conversely, consumers who seek bargains for a main product tend to seek bargains for accessories as well. Thus, given a particular main product price, the price of the allied product may be compared to the main product price. Alternatively, the price of the allied product may be required to fall below, or even exceed, a price threshold. Depending on whether the allied product's price point meets the specified criteria, the process proceeds to sub-step 303 or sub-step 309 in a manner similar to previous embodiments.

In still another embodiment, sub-step 301 may evaluate an allied product according to brand ratings. In particular, an editor may enter a list of preferred brands or a ranking of brands into the system. Such a list or ranking is used as the basis to add points to the total scalar score. If the allied product is sold under a brand on the editor's list, points are added in sub-step 309 to the total scalar score as a bonus. If the brand of the allied product is not on the list, the process may move onto sub-step 303. However, because matching a brand on the list is actually considered a bonus, an allied product that does not have a brand on the list does not have to be penalized. Therefore, from sub-step 303, no penalty is applied and the process proceeds to evaluation of other remaining criteria.

Although exemplary criteria are presented herein, it is understood that the rules applied in sub-step 301 are not limited to these criteria. Moreover, as indicated above, these examples may be applied alone or in combination, with or without other rules.

If the allied product has not been eliminated and all X number of criteria are tested, the total scalar score is determined in sub-step 311. The various point additions and deductions are combined to determine the final score. The rules for point additions and deductions may vary according to the criteria that are being applied. For instance, the additions and deductions may be weighted and tuned to reflect the relative importance of the criteria being applied. An administrator may manually record this weighting and tuning through a control panel that interfaces with the system.

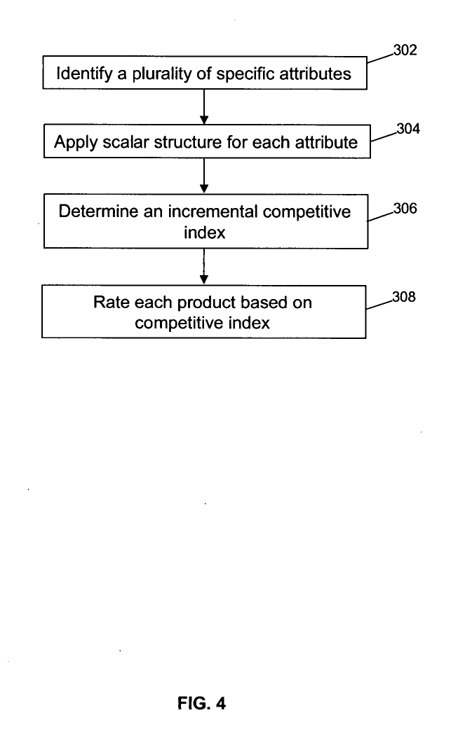

Rating and scalarization techniques that can be incorporated into step 300 are described in U.S. application Ser. No. 10/265,189, filed Oct. 7, 2002, entitled SYSTEM AND METHOD FOR RATING PLURAL PRODUCTS, the contents of which are entirely incorporated herein by reference. In general, the disclosed techniques determine a scalar rating for a product in relation to other products in the same product category, where the rating is based on the specific attributes associated with the product category. As shown in FIG. 4, an embodiment of the method disclosed in the reference includes step 302 where a plurality of specific attributes associated with a category of product is identified to compare plural products in the category. In step 304, a scalar structure is applied for each attribute to provide a scalar value of each attribute for each of the plural products. More critical attributes are weighted with higher scalar values. In step 306, an incremental competitive index is determined for each attribute of each product based on the scalar value of each attribute applied in step 304 and the number of products having the scalar value. A competitive index accounts for the number of products in a product category that have the particular scalar value representing a particular attribute. In other words, a product has a higher competitive index for a certain attribute if fewer products have that attribute. Each product is then rated in step 308 based on the competitive index determined in step 306. As such, the technique disclosed in the reference can be used in step 300 to determine relative ratings for allied products having the same product category relations with the main product. In particular, allied products with higher competitive ranks for the more highly rated attributes are given higher point bonuses.

Referring again to FIG. 2, once a rating 50 is determined in step 300 for each allied product, the allied products are ranked in step 400 in a ranked listing 60 according to the ratings 50.

From the outset, data from allied products is received as input to eventually create the ranked listing 60. Although initial data is available, allied product briefs, or content, 70 may be generated to provide additional information corresponding to each allied product. In particular, embodiments of the present invention may automatically construct a formatted explanation that provides a value proposition, or information regarding the allied products in the list 60 and their relevance to the main product 10. As shown in FIG. 2, step 500 takes the list 60 of allied products and generates text for allied product briefs 70.

Approaches to automatically generating text are disclosed in U.S. application Ser. No. 10/839,700, filed May 6, 2004, entitled SYSTEM AND METHOD FOR GENERATING AN ALTERNATIVE PRODUCT RECOMMENDATION, which is a continuation-in-part of U.S. application Ser. No. 10/430,679, filed May 7, 2003, entitled SYSTEM AND METHOD FOR AUTOMATICALLY GENERATING A NARRATIVE PRODUCT SUMMARY, the contents of these references being entirely incorporated herein by reference. Similar to the approaches disclosed in these references, generation of text for allied product briefs 70, namely variant texts, may be accomplished by using assertion models 75. An assertion is generally a point or premise of information, fact, or opinion being made by any number of possible sentences or fragments which express that point. Meanwhile, an assertion model is a set of grammatical patterns with field names which define various forms in which an assertion can manifest itself as a sentence. Assertion models 75, in the present embodiments, reference prices, brands, specifications, and secondary attributes while invoking a micro-grammar that is defined by editors across a small, domain-specific vocabulary.

To achieve the advantages of scalability, assertion models are defined at a global level (valid for all categories), where feasible. To accomplish this, slots, or fields, in the assertion models may be defined to represent very broad concepts. For example, at a high level, all allied products can each be seen as a good or service with attributes that support or enhance the continued operation of a main product by overcoming a limitation of the main product. Slots that remain valid at a global level can be identified for this general notion. For instance, slots can be used to represent: what the continued operation of the main product is, what the limitation of the main product is, and what beneficial attribute of the allied product overcomes that limitation.

This abstract paradigm is then instantiated merely by filling in the slots for each new category. If the main product is a digital camera and the allied product is a rechargeable battery, the continued operation of the main product may be “taking pictures;” the limitation of the main product is “running out of power;” and the beneficial attribute of the allied product is “providing an extra source of power.” Alternatively, if the main product is a baby stroller and the allied product is a cup holder attachment, the continued operation of the main product may be “pushing a baby from one place to another;” the limitation of the main product is “difficulty in handling a drink while pushing the stroller;” and the beneficial attribute of the allied product is “providing a receptacle to hold the drink in a secure accessible position.”

Many variations within the scope of the present invention exist for such a scheme. For example, the system may generate random variance in the grammar and style, as disclosed in U.S. application Ser. Nos. 10/839,700 and 10/430,679. Nevertheless, the examples above demonstrate that standard slots—here, “continued operation,” “limitation,” and “beneficial attribute”—can be established for global use, and thus assertion models 75 may be defined with such slots to work on a global level. These models and their variations do not need to be re-created for each category. In the examples above, only the three slots need to be filled. Advantageously, meaningful texts for new categories of allied products are rapidly generated in a highly scalable manner.

U.S. application Ser. Nos. 10/839,700 and 10/430,679 describe a generic explanation function that may be employed to trigger an explanatory statement when a specific attribute has been previously mentioned. A similar mechanism is employed in the present embodiments. However, rather than merely explaining a feature of a product, the explanation used in the present embodiments describes the relationship between the allied product and the main product with respect to a particular feature. For example, such an explanation may state, “For your ultra-portable notebook with Bluetooth, you'd benefit by getting this small Bluetooth wireless mouse—handy in tight places like trains and airplanes.” The explanation may be developed from the following logical steps in the system:
1. The notebook is ultraportable in form-factor.
2. The notebook is business-oriented in its usage scenario.
3. The notebook is Bluetooth capable.
4. The candidate mouse is also ultraportable in form-factor.
5. The candidate mouse is also Bluetooth capable.
6. The attributes regarding Bluetooth, ultraportable, and business-oriented call for explanation of the convenience of small wireless devices in common modes of business transportation such as trains and airplanes.

Once the logical tests performed by the system lead it through step 6 above, the appropriate assertion model is chosen. For instance, editors may define variant assertion templates, with two levels of variation. The templates are varied, and for each template, vocabulary selection is also varied. Thus, a random template is chosen. Then, within that template, the micro-grammar is determined and the random vocabulary selections are made in order to arrive at the finished text.

In steps 100 through 500, an initial pool of allied products 20 has been identified and ranked according to ratings 50 based on particular attributes. In addition, product briefs 70 have been created for each allied product. Although some rules may be applied in step 300 to restrict the number of candidate allied products in consideration, the results 60 of step 400 remain a general list of candidate allied products and is generally the sum total of most, if not all, identifiable products. In these steps, any rules that have been applied to the selection and ranking of the allied products have been generically created by editors/product experts, particularly at initial set-up of the system.

As discussed in detail below, business rules may be applied in subsequent steps to optimize the general list and reduce it to the most relevant allied products. Often such business rules are quite specific to the merchant applying the rules. Once these rules are applied to optimize the general list, the result is only useful to the specific merchant. As such, the general list may be employed in a third-party editorial context, such as an online product review, which does not have the business requirements of a retail channel. Advantageously, this allows an editorial person to start from a more universal perspective, uninfluenced by specific business rules. Indeed, any rules that have been applied have been those applied by the editors. Thus, the ratings 50 and the ranked list 60 have incorporated some editorial rules and may be used by editors as the basis for further product analysis.

Nevertheless, for a merchant, the initial pool of allied products 20 must be pared down, at least for the most obvious reason that the merchant probably does not sell all products in the initial pool. Clearly, the candidate allied product pool 20 must be further limited to what a particular merchant actually carries in stock, which is, except in the rarest of cases, a subset of all allied products. Therefore, as shown in FIG. 2, input into step 600 includes the ranked list 60 of allied products, which results from step 400. Additional input includes optimization rules 80 that reflect the specific requirements of merchants. Step 600 applies these optimization rules 80 to the ranked list of candidate allied products 60 to produce an optimized list 99 of allied products. Through the application of business rules, step 600 further refines the rankings or ratings provided in the ranked list 60.

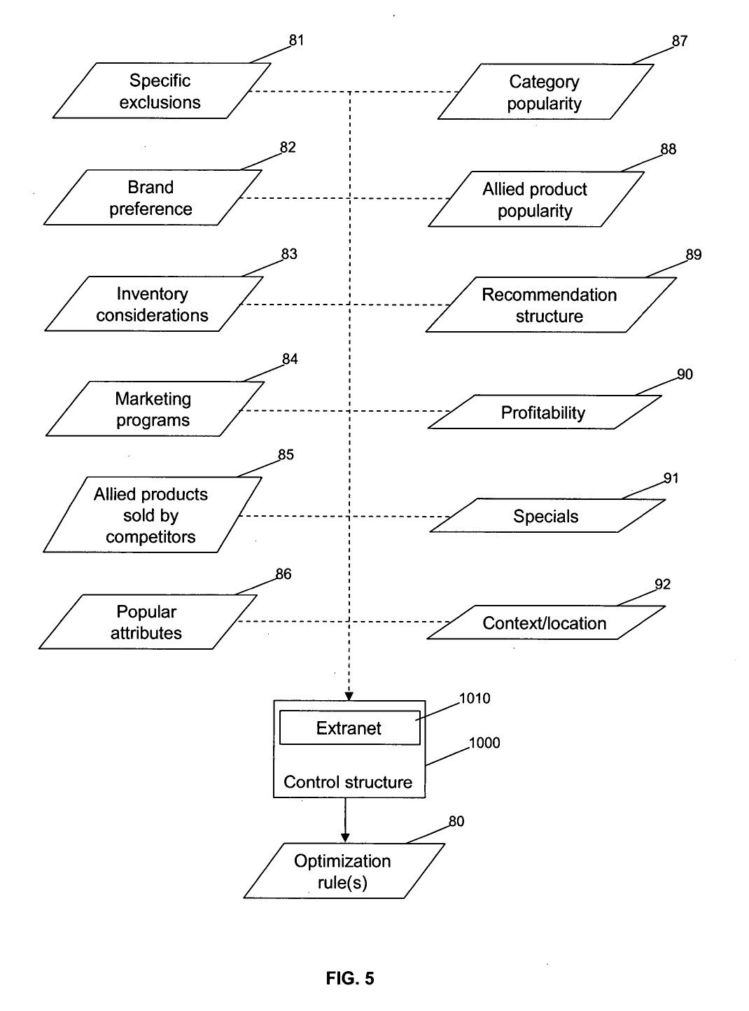

Embodiments of the present invention provide a control structure 1000, as depicted in FIG. 5, to allow individual merchants to select, or to influence selection of, allied products from the initial pool of candidate allied products created in earlier steps. In particular, the control structure 1000 may include extranet tools 1010 which provide an interface 1012 for merchants to provide input for the creation of an optimized list 99 of allied products. This input forms the basis for the optimization rules 80.

The control structure 1000 and the user interface 1012 may faciliate workflow for merchants. For instance, attributes can be filtered and/or visually coded according to their prevalence in products. If a merchant is making a rule for cross-selling mice to notebooks, the available mice attributes can be visually coded green, yellow, and red, with green indicating that most mice have the attribute, yellow indicating some mice have the attribute, and red indicating that few mice have the attribute. The default behavior of the user interface may then be configured to show only green attributes, thereby making it easier for the user to choose prevalent attributes.

As discussed previously, in an exemplary application, the optimized list of allied products created in step 600 represents products that are cross-sold by a merchant with the main product on an online retail website. In this online application, allied products are generally cross-sold in two different formats: an uncategorized short list or a categorized list.

An uncategorized short list typically appears on the same webpage as the main product. An uncategorized short list presents a small number of recommendations (e.g. 1 to 5 recommendations) for allied products in association with the main product. These recommendations may correspond directly with specific allied products or may present categories of allied products. For instance, an uncategorized short list may present the following content on a web page selling a laptop: “Protect your computer with a great-looking travel case. Click here to see choices for the [product short name], starting at [lowest price of matching cases].” Hyperlinks in the content direct consumers from the webpage selling the main product to another webpage with a categorized list of actual allied products that match the main product.

Thus, a categorized list typically appears on a webpage that is separate from the webpage selling the main product. As such, the separate webpage in one case may be the second webpage of an order process which appears after a customer has added the main product to an online checkout cart. In another case, the separate webpage may be an “Accessories” webpage dedicated to content associated with allied products. Preferably, a categorized list presents organizes the allied products according to category and presents a generated sub-heading for each category explaining the benefits of buying an allied product under the category. Additionally, each allied product may be presented with a generated allied product brief that explains the relative benefits of the particular allied product. For instance, the explanation may point out differences with other allied products.

Although the typical categorized list may have many allied product categories, a categorized list may present allied products in a single product category. In the example above, the hyperlinks from the uncategorized short list would direct the consumer to a categorized list that only presents computer cases that fit the main product.

Embodiments of the present invention enable a merchant to cross-sell allied products according to an optimized list. The optimization rules 80 for creating this optimized list 99 may apply to the following situations (scope):
when all product are involved (global)
when a specific main product category is involved
when a specific allied product category is involved
when a specific main product category and a specific allied product category are involved (intersect)
when a specific main product is involved
when a specific main product and a specific allied product category are involved (intersect)
when a specific main product category and a specific allied product are involved (intersect)
when a specific main product and a specific allied product are involved (intersect)

A rule that applies when a specific main product and a specific allied product are involved essentially entails a hard-wired choice that expressly ties an allied product to a main product. In some cases, merchants may want to hard-wire one or more specific allied products to the sale of a specific main product.

FIG. 5 illustrates various examples of business-related factors that may be translated into optimization rules 80. By considering such factors, the optimization rules 80 ensure that the list of allied products provided to merchants is relevant and reflects their business needs. For online merchants, business needs include the manner in which allied products are presented on a website. Thus, the optimization rules 80 may depend on how the online merchant employs the uncategorized short list or categorized list described previously.

In some cases, the optimization rules reflect the merchant's desire to make particular products simply ineligible for consideration as cross-sell items for a main product. Thus, FIG. 5 depicts specific exclusions 81 as a possible consideration in the creation of optimization rules 80. Exclusion of specific products may be the result of an agreement with a manufacturer not to cross-sell its products with products from another manufacturer. For example, a camera retailer may have an agreement with Manufacturer A not to cross-sell lenses from Manufacturer B with cameras from Manufacturer A. On the other hand, exclusion of specific products may result merely from the merchant's own opinion that users of a computer from Manufacturer C do not buy mice produced by Manufacturer D. The extranet 1010 allows merchants to establish rules for these types of exclusions to further define the pool of allied products.

In other cases, a merchant may want a preferred brand of allied product to be emphasized wherever possible, but may not want to rule out other brands entirely. Thus, a merchant may push a preferred brand wherever possible, but if an allied product under a preferred brand is not in stock, another brand is promoted. In one embodiment, such rules are inputted by the merchant as Boolean rules. In another embodiment, the merchant inputs a ranked or weighted ordering of brands, so that higher-ranked brands are emphasized for cross-selling. Therefore, FIG. 5 depicts brand preference 82 as another factor to consider in developing the optimization rules 80.

Conversely, a merchant (or editorial recommender) may prefer to avoid a particular brand whenever possible, while allowing that if it is the only brand that offers a compatible accessory of a certain type, then it may be recommended. Alternatively, the restrictions on allied product selection can be combined with a designation of necessity for certain allied product types. For example, the reseller may believe it is absolutely vital to recommend at least one external hard drive for any laptop having less than 30 GB size internal hard drive, even if an external hard drive cannot be found in current inventory of the preferred brand, price, etc. whereas the reseller may at the same time wish to recommend a trackball for the same laptop if and only if there is one in stock of the preferred brand and price point.

As discussed above, the optimized list 99 of allied products must be tied to the merchant's inventory. Thus, inventory considerations 83, as shown in FIG. 5, may be a consideration for optimization rules 80. If a merchant does not stock a particular allied product, an optimization rule eliminates that allied product from the optimized list 99. Additionally, an allied product may be eliminated if the merchant is temporarily out of stock or is at low inventory level. Conversely, if a particular allied product has a particularly high level of inventory, an optimization rule may favor selection of that particular allied product. An updated inventory file is required to apply inventory-related optimization rules. Alternatively, a real-time or just-in-time inventory check procedure may be invoked.

As shown in FIG. 5, optimization rules 80 may be influenced by marketing programs 84 that a merchant offers to manufacturers. A manufacturer selects a particular marketing program for the products it sells through the merchant. For instance, an online merchant may offer Gold, Silver, and Bronze marketing programs, where allied products sold under the Gold program appear on a webpage above products sold under the Silver program and allied products sold under the Silver program appear on a webpage above products sold under the Bronze program. A corresponding optimization rule may order or rank the allied products on the optimized list according to such a marketing scheme. Moreover, the optimization rule may ensure that all allied products under any of the marketing plans appear on the optimized list.

As further illustrated in FIG. 5, optimization rules 80 may take into account allied products 85 sold by a competitor. If the merchant sells an allied product that it also manufactures, an optimization rule may eliminate any allied products sold by a competitor in the same product category.

In addition, popular attributes 86 may influence optimization rules 80. Thus, an optimization rule may order or rank the allied products on the optimized list according to the availability of highly popular features on the allied product. For example, Bluetooth functionality may be a highly sought-after feature. Thus, allied products with Bluetooth may be positioned at the top of the optimized list. Allied products with Bluetooth may be accompanied by a generated pitch such as: “The [computer short name] includes Bluetooth, a feature that allows you to eliminate the tangle of wires. To take advantage of this feature, we recommend the [Bluetooth-compatible product], which will work with the [computer short name] wirelessly.”

Furthermore, the popularity 87 of a product category may also influence optimization rules 80. For instance, when an online merchant presents an uncategorized short list to cross-sell allied products, the categories of allied products included in the uncategorized short list may be selected according to:
1) the popularity of each allied product category in relation to the main product,
2) the popularity of each allied product category in relation to the main product category, or
3) the overall popularity of each allied product category.
   Simple popularity may be alternatively replaced by a weighted or biased popularity, such as popularity among the most valued customers, e.g. repeat customers, customers with higher-than-average purchase volume, etc.

Thus, to enable the merchant to present allied products in this manner, an optimization rule may order or rank the allied products according to the popularity of their product categories. The ability to assess the levels of popularity above depends on the amount of transactional data available. The amount of data required to assess the popularity of each allied product category generally decreases as one moves from items 1) to 3) in the list immediately above. Thus, item 2) may be used if not enough data is available to assess item 1), and item 3) may be used if not enough data is available to assess item 2). Data collected to determine the popularity of each allied product category may be collected with respect to a particular merchant. However, if not enough data is available, data can be collected from multiple merchants and aggregated.

Similarly, optimization rules 80 may consider the popularity 88 of each specific allied product. For instance, when an online merchant lists allied products for a particular allied product category, allied products may be listed on a web page according to:
1) the popularity of each allied product in relation to the main product,
2) the popularity of each allied product in relation to the main product category, or
3) the overall popularity of each allied product.
   Popularity rules can be based on dynamic attributes that are computed at run time. For example, a rule might require ordering allied products by popularity, where popularity is determined by the following steps: 1) Rank the allied product's popularity against other accessories only when cross-sold against a particular parent product; if the numbers are too low reliable rankings, go to step 2; 2) Rank the allied product's popularity against other allied products when cross-sold against all products in the parent category; if the numbers are still too low for reliable rankings; go to step 3; 3) Rank the allied product's popularity against all other allied products for all sales.

Thus, to enable the merchant to present allied products in this manner, an optimization rule may order or rank the allied products according to the popularity of each allied product. When listing allied products according to the popularity of the allied product, the merchant must avoid creating locked loops, where a new allied product never becomes popular because it is never recommended among the popular allied products. Alternatively, to guard against such loops, the rules-based system can work in conjunction with a more statistically oriented selection system, such as a collaborative filter. A collaborative filter is a system that takes into account situations where people who buy product A also buy product B (i.e., “people who bought this also bought that”). The respective systems could be pre- or post-processors for each other. The virtue of that relationship is that an allied product that may be inadvertently locked out due to the merchant's procedural rules has a chance of rising to candidacy through the statistical processor, or conversely, an allied product that does not emerge on the collaborative filter may nonetheless be captured by the merchant's systematic rules.

As shown in FIG. 5, an optimization rule 80 may also be based on aspects of the merchant's recommendation structure 89. For example, when recommending a small number of allied products for a main product, no more than one allied product is selected from a product category. As a further example, the merchant may require a different number of recommendations for different allied product categories. Or as yet another example, the merchant may not recommend anything that costs more than 20% of the parent product's price.

Another factor relates to profitability 90. In general, a merchant's recommendations are biased toward allied products that are most profitable. As such, default optimization rules may employ profitability data in connection to product categories based on industry norms. For example, an optimization rule may take into account that computer cases tend to be more profitable than computer memory. In addition, to default rules, merchants can provide other profitability-related data that can form the basis of additional optimization rules, such as:
profitability data on allied product categories classified into profitability levels, e.g. low, medium, high
profitability data on allied products classified into profitability levels, e.g. low, medium, high
actual profitability numbers on allied products

Yet other optimization rules may be based on cross-sell specials 91, where a certain allied product must be pushed under a few, limited conditions. Such optimization rules can be set to temporarily override other rules.

Because an online merchant may present the same main product on a number of different web pages, the merchant may want to apply different rules for the different web pages. For example, when consumers encounter cross-sells in direct proximity to the main product web page, they may have a higher price tolerance. However, when consumers encounter cross-sells shown at the end of the checkout process, they may have a lower price tolerance. Therefore, the context/location 92 of the cross-selling is a possible business factor. As such, optimization rules 80 are created to provide more expensive allied products when consumer price tolerance tends to be higher and to provide cheaper, impulse-type items when consumer price tolerance tends to be lower.

As illustrated in FIG. 2, optimization may also be based on user feedback 95 to the system. User feedback includes, but is not limited to, scores from user reviews, the number of user reviews, the number of recent user reviews across a single website or multiple websites, the number of professional reviews and their average rating, the number of information requests on each allied product, the number of searches on each such product, the number of product returns, the number of recent mentions in news media, the number of positive versus negative mentions in news media, and many other data indicating the reception of a product among experts and consumers alike. User feedback 95 may be inputted to the system to influence the optimized list 99.

As further illustrated in FIG. 2, step 700 outputs the optimized 99 list of allied products. As the foregoing description of business-related factors makes evident, the output required from the optimization rules, i.e. the data in the optimized list, is highly interrelated with the presentation of allied product data, particularly on an online retail web site.

The output from step 700 is provided according to a variety of output parameters specified by the merchant receiving the data and presenting the data. The outputted optimized list of allied products may include the allied product briefs generated in step 500. Furthermore, for each allied product, the output may include text, graphic, price, specification data, or any combination thereof.

For example, a merchant may want the top five ranking allied products from the ranked list along with allied product briefs, but without the accompanying ratings used to rank the five allied products. In another example, a merchant may want up to three allied products per main product, but only if the score of the allied product is above a certain threshold, i.e. the merchant does not want information on allied products if they are not fairly strong in relevance. In yet another example, a merchant may want up to present three allied products as long as their ratings are above a certain threshold, but the merchant may want at least one allied product to be display, regardless of whether its relevance is above the threshold or not.

Additionally, a merchant may want to receive the allied products grouped by category (as shown as reference numerals 21, 23, 25, 27 in FIG. 1) or by class (e.g. accessory, part, supply, connector, etc.). The latter distinction may be useful because supplies may need to be replenished periodically, and thus, the merchant may decide to e-mail the buyer several weeks after purchase to see if the buyer is interested in more supplies. Similarly, parts are not needed when an item is new but may be needed some time later. As a result, a merchant might want to exclude parts at the point of sale, but e-mail the user perhaps later to determine whether the customer requires parts. For these reasons, the appropriate groupings of the allied products might be desired by the merchant. Once the groupings are established, the merchant may want to control how the allied products are ordered, or may allow the system provide the ordering.

Although examples of optimization rules are provided above, it is understood that in some cases, a merchant may want every single item on the ranked list 60 created by step 400 to be provided, i.e. optimization rules are not applied. However, the ratings 50 are utilized for ranking the allied products when presented.

The hierarchy of categories used to identify candidate allied products and determine their relevant attributes for optimized selection and content generation is generally based on how merchants categorize their products. However, it is possible to create virtual categories, which do not reflect categories used directly by the merchants, but which are useful for creating selection rules or generating natural language for allied product content. For example, a merchant might have a Television category that includes various types of televisions which are not expressly subcategorized. If a merchant wishes to create rules or natural language based on the distinction between Plasma Televisions and LCD Televisions, appropriate virtual categories may be created. Virtual categories are treated just like other categories. Although it may be possible to achieve the same cross-sell or natural-language output without virtual categories, significantly more complex rules are required. Advantageously, virtual categories eliminate the need for such rules and facilitates rule creation and content generation.

The hierarchy of categories may also be further dimensionalized so that there can be multiple hierarchies of categories, each with their own distinct rule sets. These dimensions support different output for the same categories based on contextual differences. For example, output A may apply to an online website's main product pages, and output B may apply to the website's “Add to cart” page.

For online retailing, one exemplary purpose of the optimization in step 600 is to increase the click rate of cross-sells on online retail web pages. As with pay-for-performance advertising networks the click is the key performance and transactional metric, mainly because it is easy to measure.

In many cases, optimization rules 80 apply to situations where a specific main product category and a specific allied product category are involved (intersect). For example, at the intersection of “laptop computers” and “mice,” an online merchant might have the following rules:
1) Do not show a cross-sell if the allied product's inventory is less than 3.
2) If the notebook has Bluetooth, select only Bluetooth mice.
3) Promote to the top of the list products by Brand X or Brand Y.

Optimization rules 80 may exist in a category hierarchy and may be inherited. Thus, rule 1) immediately above may be defined for the intersection of “all parent products” and “all allied products.” It would then be inherited by every intersection below, unless it is specifically overridden at a lower level. This behavior allows for general rules to be written once and used widely.

The rules may be applied against a list of all possible allied products for the intersection—in our example, all possible mice for a notebook computer. When executed, the optimization rules filter and reorder the list of allied products 60. However, after the rules execute, the list may still be longer than the number of spaces available to display allied products on a web page. For example, the merchant might only want to show one mouse, but after the rules execute, there may be six Bluetooth mice by Brand X and Brand Y.

This “tied” situation within a cross-sell category may be resolved by further optimization. In the present example, the goal for optimization is to pick the best mouse to maximize clicks on the cross-sales of that mouse. The data available to optimize further includes:
Detailed attributes for all allied products involved
For every web page with cross-selling, comprehensive cross-sell impressions and clicks (cross-sells that were served, the location of cross-sells on the web page, and the cross-sells that were clicked.)
Editorial ratings

Several techniques for breaking n-way ties are available. One approach involves choosing the most popular mouse, according to the popularity tracked in terms of page views. Another approach involves choosing the mouse with the highest click rate when cross-sold. In yet another approach, multivariable rule components may be applied, such as a composite metric of click rate and profitability.

When using popularity-based metrics, there are two notable challenges:
Avoiding locked-loop scenarios, where the system never picks new accessories to cross-sell because they have not yet become popular, and in so doing, ensures that they never become popular.
Dealing with low-base-rate performance data at the intersection of a main product with specific allied products. That is, preferably optimization is based on the performance of specific allied product against a particular main product for a given customer, thereby optimizing for the most relevant context. However, the number of cross-sell impressions and clicks at this intersection (main product by allied product by customer) is generally too low to be useful in most cases, thus implying the need for coarser optimizations such as those mentioned above (e.g., choose the most popular mouse). A way around this problem is to aggregate performance data across many customers, thereby lifting the base rates.

In cases where a new main product is involved and there is insufficient data to know how well various accessories perform with it, a “popularity by proxy” technique may be employed: (1) identify products that are feature-equivalent to the new parent product; and (2) use the best-performing accessories across these similar products.

Optimization rules 80 may also increase click rates for an online merchant in additional ways. For instance, some online merchants may order allied products by category on a web page, e.g. the mouse goes at the top, the keyboard is second, and so on. In this case, optimization may maximize clicks by choosing the best order for a given parent product's cross-sells to appear. The allied products may be ordered according to popularity in terms of page views or tracked click rates in a cross-selling context. Randomized tests may also be used to assess what works best vis-a-vis a main product or category.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

What is claimed is:

1. A method for processing product data, the method comprising:
identifying a plurality of allied products associated with a main product;
determining a product category relation categorizing each allied product with respect to the main product;
determining at least one attribute for each allied product according to the product category relation;
determining a rating for each allied product; and
ranking, in a ranked list of allied products, each allied product according to the rating of each allied product; and
determining an optimized list of allied products by applying at least one rule to the ranked list of allied products.

2. The method according to claim 1, wherein the step of identifying a plurality of allied products associated with a main product comprises identifying a plurality of allied products that are compatible with a usage scenario.

3. The method according to claim 1, wherein the main product is characterized by a defined product category relationship that is inherited from another product.

4. The method according to claim 1, wherein the step of determining a rating for each allied product comprises determining a scalar value for each allied product.

5. The method according to claim 4, wherein the step of determining a scalar value for each allied product comprises adding points or deducting points according to the at least one attribute of each allied product.

6. The method according to claim 5, wherein the step of adding points or deducting points according to the at least one attribute of each allied product comprises assigning a weighting value to the at least one attribute.

7. The method according to claim 1, wherein the step of determining a rating for each allied product comprises determining a rating for each allied product according to at least one attribute in connection with a usage scenario.

8. The method according to claim 1, wherein the step of determining a rating for each allied product comprises determining a rating for each allied product according to a comparison of each allied product with the main product.

9. The method according to claim 8, wherein the step of determining a rating for each allied product according to a comparison of each allied product with the main product comprises comparing an allied product value with a main product value for an attribute common to each allied product and the main product.

10. The method according to claim 1, wherein the step of determining a rating for each allied product comprises determining a rating for each allied product according to a price of each allied product.

11. The method according to claim 1, wherein the step of determining a rating for each allied product comprises determining a rating for each allied product according to a brand of each allied product.

12. The method according to claim 1, further comprising automatically generating, for each allied product, a variant text that describes the allied product.

13. The method according to claim 12, wherein the variant text provides a value proposition for the allied product.

14. The method according to claim 12, wherein the step of automatically generating, for each allied product, a variant text that describes each allied product comprises selecting a template, and, for each allied product, combining the template with data regarding the allied product.

15. The method according to claim 1, wherein the step of determining an optimized list of allied products by applying at least one rule to the ranked list of allied products comprises receiving the at least one rule from a control structure.

16. The method according to claim 15, wherein the control structure is an extranet.

17. The method according to claim 1, wherein the step of determining an optimized list of allied products by applying at least one rule to the ranked list of allied products comprises selecting, from the ranked list of allied products, selected allied products according to product category.

18. The method according to claim 1, wherein the at least one rule comprises a set of rules organized in a category hierarchy.

19. The method according to claim 1, wherein the step of determining an optimized list of allied products by applying at least one rule to the ranked list of allied products comprises selecting, from the ranked list of allied products, selected allied products according to the rating of each allied product.

20. The method according to claim 19, wherein the rating of each selected allied product exceeds a threshold.

21. The method according to claim 1, wherein the step of determining an optimized list of allied products by applying at least one rule to the ranked list of allied products comprises weighting each allied product according to an attribute of the allied product.

22. The method according to claim 1, wherein the step of determining an optimized list of allied products by applying at least one rule to the ranked list of allied products comprises receiving opinion data from users of the ranked allied products in the ranked list and determining an optimized list of allied products according to the opinion data.

23. The method according to claim 1, wherein the step of determining an optimized list of allied products by applying at least one rule to the ranked list of allied products comprises receiving transactional data from an online system and determining an optimized list of allied products according to the transactional data.

24. The method according to claim 23, wherein the transactional data comprises metrics based on clicks by users on the online system.

25. The method according to claim 1, wherein the step of determining an optimized list of allied products by applying at least one rule to the ranked list of allied products comprises applying a tie-breaking rule.

26. The method according to claim 1, further comprising cross-selling, with the main product, at least one cross-sold allied product from the optimized list of allied products.

27. The method according to claim 26, wherein the step of determining an optimized list of allied products by applying at least one rule to the ranked list of allied products comprises receiving the at least one rule from a seller cross-selling, with the main product, the at least one cross-sold allied product.

28. The method according to claim 27, wherein the step of cross-selling, with the main product, at least one cross-sold allied product from the optimized list of allied products comprises grouping the at least one cross-sold product according to type or class.

29. The method according to claim 27, wherein the step of receiving the at least one rule from a seller cross-selling, with the main product, the at least one cross-sold allied product comprises receiving at least one rule based on at least one of: specific exclusions; brand preference; inventory considerations; marketing programs; products sold by competitors; popular attributes; category popularity; allied product popularity; recommendation structure; profitability; context or location of cross-sell; and cross-sell specials.

30. A system for processing product data, the system comprising:
a plurality of allied products associated with a main product;
a product category relation categorizing each allied product with respect to the main product, the product category relation determining at least one attribute for each allied product;
a rating scheme that determines a rating for each allied product and provides a ranked list of allied products according to the rating of each allied product; and
an optimizer that provides an optimized list of allied products by applying at least one rule to the ranked list of allied products.

31. The system according to claim 30, wherein the plurality of allied products associated with the main product are compatible with a usage scenario.

32. The system according to claim 30, wherein the main product is characterized by a defined product category relationship that is inherited from another product.

33. The system according to claim 30, wherein the rating scheme determines a scalar value for each allied product.

34. The system according to claim 33, wherein the scalar value for each allied product comprises points added or deducted according to the at least one attribute of the allied product.

35. The system according to claim 34, wherein the at least one attribute has a weighted value.

36. The system according to claim 30, wherein the rating for each allied product is based on the at least one attribute in connection with a usage scenario.

37. The system according to claim 30, wherein the rating for each allied product is based on a comparison of each allied product with the main product.

38. The system according to claim 37, wherein the rating for each allied product is based on a comparison of an allied product value with a main product value for an attribute common to each allied product and the main product.

39. The system according to claim 30, wherein the rating for each allied product is based on a price of each allied product.

40. The system according to claim 30, the rating for each allied product is based on a brand of each allied product.

41. The system according to claim 30, further comprising a text generator that produces a variant text, for each allied product, that describes the allied product.

42. The system according to claim 41, wherein the variant text provides a value proposition for the allied product.

43. The system according to claim 41, wherein the variant text comprises a template combined with data regarding the allied product.

44. The system according to claim 30, further comprising a control structure through which the at least one rule is provided.

45. The system according to claim 44, wherein the control structure is an extranet.

46. The system according to claim 30, wherein the at least one rule selects, from the ranked list of allied products, selected allied products according product category.

47. The system according to claim 30, wherein the at least one rule comprises a set of rules organized in a category hierarchy.

48. The system according to claim 30, wherein the at least one rule selects, from the ranked list of allied products, according to the rating of each allied product.

49. The system according to claim 48, wherein the rating of each selected allied product exceeds a threshold.

50. The system according to claim 30, wherein the at least one rule weights each ranked allied product in the ranked list according to an attribute of the ranked allied product.

51. The system according to claim 30, wherein the at least one rule selects, from the ranked list of allied products, selected allied products according to opinion data received from users of the ranked allied products in the ranked list.

52. The system according to claim 30, wherein the at least one rule selects, from the ranked list of allied products, selected allied products according to transactional data received from an online system.

53. The system according to claim 52, wherein the transactional data comprises metrics based on clicks by users on the online system.

54. The system according to claim 30, wherein the at least one rule includes a tie-breaking rule.

55. The system according to claim 30, wherein the main product is cross-sold with at least one cross-sold allied product from the optimized list of allied products.

56. The system according to claim 55, wherein the at least one rule is received from a seller cross-selling, with the main product, the at least one cross-sold allied product.

57. The system according to claim 56, wherein the at least one cross-sold allied product is grouped according to type or class.

58. The system according to claim 56, wherein the at least one rule is based on at least one of: specific exclusions; brand preference; inventory considerations; marketing programs; products sold by competitors; popular attributes; category popularity; allied product popularity; recommendation structure; profitability; context or location of cross-sell; and cross-sell specials.
